(19) United States
(12) Patent Application Publication
(10) Pub. No.: US 2021/0106475 A1
(43) Pub. Date: Apr. 15, 2021

(54) DISPOSABLE CLEANING AUXILIARY TOOL

(71) Applicant: WANOCARE CO., LTD., Chiba-shi, Chiba (JP)

(72) Inventors: Yukie Nagai, Chiba-shi (JP); Akie Kawabata, Oshima-gun (JP)

(73) Assignee: WANOCARE CO., LTD., Chiba-shi, Chiba (JP)

(21) Appl. No.: 17/047,895

(22) PCT Filed: Nov. 19, 2018
(86) PCT No.: PCT/JP2018/042637

§ 371 Date: Oct. 15, 2020

(30) Foreign Application Priority Data
Apr. 19, 2018 (JP) 2018-080378

(51) Int. Cl. A61G 7/00; A45D 19/06

(52) U.S. Cl. CPC A61G 7/0005; A45D 19/06

(57) ABSTRACT

The disposable cleaning auxiliary tool comprises a flexible sheet-like non-liquid-permeable material being made to have a bottom portion, a duct portion arranged so as to extend further therebeyond from a location serving as soiled water outlet provided at an outer periphery of said bottom portion, a pouch-like water-receiving portion arranged at a surface at one side or surfaces at both sides of an extended tip of said duct portion, a cylindrical gas filled portion arranged at an outer peripheral portion other than the location serving as soiled water outlet at said bottom portion, and a gas filling inlet for filling said cylindrical gas filled portion, and is capable of being folded and stored when the cylindrical gas filled portion is not filled with gas, a concavity formed when the body of the bedridden individual pushes downward serves as a reservoir, another concavity formed serves as a drainage path.

### TECHNICAL FIELD

The present invention relates to a disposable cleaning auxiliary tool such as will permit a caregiver or the like, when giving a shampoo to a bedridden individual or when carrying out cleaning of the lumbar region, gluteal region, or other such hard-to-clean region of a bedridden individual while that individual is still in bed, to manage water use without the inconvenience that would otherwise be associated with preparation or with cleanup afterwards.

### BACKGROUND ART

At hospitals, nursing homes, and so forth, shampoos are routinely given to patients, persons requiring nursing care, and other such bedridden individuals who while confined to bed or futon bedding are unable on their own to move their bodies as they would like. This is because shampooing of bedridden individuals is thought to be an important form of patient care not only from the standpoint of hygiene inasmuch as it allows the cleanliness of head hair to be maintained, but also because it can be expected to be effective in allowing the bedridden individual to become both physically and mentally relaxed.

In an attempt to address the foregoing need, as a special-purpose implement for giving shampoos to bedridden individuals, a shampoo auxiliary tool called a Kelly pad which is made of rubber, or a homemade shampoo auxiliary tool of similar constitution, has therefore conventionally been frequently used. Such shampoo auxiliary tools are provided with a rubber pad on which the head and neck of a bedridden individual can be laid, and a flow path that is contiguous with said pad.

When using the foregoing rubber pad to give a shampoo to a bedridden individual, the foregoing rubber pad is first inserted in the space between the upper surface of the bed and the underside of the head and neck of the bedridden individual, and one end of the flow path that is contiguous with said pad is arranged at a location at the top face of the opening of a bucket which is placed below the bed in which the bedridden individual lies. In addition, while in this state, shampooing is carried out as water is poured onto the head hair from a location above the head of the bedridden individual. The water that is poured onto the hair quickly flows over the rubber pad, is guided down the flow path that is contiguous therewith, and collects within the bucket that was placed beneath the bed. This being the case, it is supposed to be the case that a shampoo can be given to a bedridden individual without getting the bed or futon bedding wet.

However, because the foregoing pad is made of rubber it has a high coefficient of friction, which will cause the sheets on the bed to be moved out of place when the pad is inserted between the bedridden individual and the bed, and so it is not suited to situations in which the task is being done by a single person. Furthermore, whereas it is necessary during the shampoo procedure to pour an adequate amount of water onto the head hair so that shampoo and/or conditioner can be washed off therefrom, the foregoing pad, because it is made of rubber, does not deform but remains flat, as a result of which water does not pool thereabove but flows quickly over the surface thereof. This being the case, if even for a moment the amount of water that is being poured thereonto is even slightly too much, the soiled water will leak via the side of the flat flow path that is contiguous with the foregoing pad and cause the bed and/or the bedridden individual to become wet. Furthermore, because any change in the amount of water being used for cleaning will cause the end of the flow path to move in such fashion that it jerks up and down due to the elasticity of the rubber, the location of the end thereof will become dislodged from the top face of the opening of the bucket which is disposed beneath the bed, causing soiled water to spill onto the floor. For this reason, as serious attention must be adequately given to handling during cleaning, and formulation of standardized work procedures has been difficult, improvement has been desired.

Moreover, whereas it is necessary during the shampoo procedure to pour an adequate amount of water onto the head hair so that shampoo and/or conditioner can be washed off therefrom, because the foregoing pad, inasmuch as it is made of rubber, does not deform but remains flat, causing water not to pool but to drain therefrom, a large amount, i.e., more than 5 L, of water is necessary to adequately carry out shampooing of the entire head including the back of the head which corresponds to the underside of the bedridden individual, and it will moreover be necessary partway through the procedure to replace the bucket and discard the soiled water, and so forth, making work operations complicated. In addition, because shampoo and conditioner, and bacteria and unclean components produced during shampooing of the bedridden individual, tend to adhere to the rubber surface, there is the inconvenience that is associated with hygienic procedures; and especially in situations where it is to be reused, as it is essential that cleaning treatment, disinfection treatment, and drying treatment be adequately carried out, considerable amounts of clean water, separate from whatever water is used for shampooing, are required for each of these various types of treatment. This being the case, the situation has been such that this has impeded use during disasters and in locations where use of water is problematic.

Thus, because preparation and cleanup afterwards are troublesome, and also because there is much concern that there will be leakage of water during use, it is necessary for inexperienced workers and workers who will be performing operations by themselves to undergo adequate education and training in advance, and so it cannot be said that this is a shampoo auxiliary tool that is capable of being easily handled by anyone including beginners, for which reason measures to address this have been sought.

Furthermore, the foregoing pad, inasmuch as it is made of rubber, cannot easily be made compact to allow it to be placed in a container, space being required for transport and storage thereof. Moreover, rubber products are costly and inconvenient to manufacture, and do not lend themselves to being made disposable.

A shampoo auxiliary tool has therefore been proposed in which high-molecular-weight polymer absorbent material or other such absorbent which will cause the water that was used during shampooing to be absorbed is disposed at the pad so as to prevent the bed and the bedridden individual from getting wet when soiled water leaks out (see Patent Reference No. 1 and Patent Reference No. 2).

However, because the shampoo auxiliary tools described at the foregoing respective Patent References employ absorbents that are high-molecular-weight polymer absorbent materials or the like so as to cause water to be absorbed, they are such that their manufacturing cost is high. Furthermore, because they cause soiled water to be absorbed by a high-molecular-weight polymer absorbent material at the periphery of the head, there is the problem that unclean components will, following shampooing, continue to remain on the surface of the high-molecular-weight polymer absorbent material at the periphery of the head, as a result of which it will not be possible to achieve a highly clean state at the head of the person undergoing the procedure. Moreover, as the high-molecular-weight polymer absorbent material is also used in diapers, the fact that there will be psychological resistance to this on the part of the bedridden individual who is the person undergoing the procedure is viewed as problematic. In addition, due to the sudden increase in recent years in the total amount of used diapers that are being disposed of, the trash which results from the used high-molecular-weight polymer absorbent material has been a problem for society in terms of how it should be processed, and as the used pads that have absorbed soiled water occupy greater volume and there are communities that require these to be treated as nonflammable trash when they are being disposed of because of the reduced efficiency with which they are incinerated and the like, disposal thereof has necessitated inconvenience and cost. Furthermore, the amount of water required to give a shampoo to a bedridden individual already being large, improvement has also been sought with respect to the fact that these do not permit the soiled water to be put to another use.

Furthermore, where the period during which the bedridden individual has been confined to bed continues for a long time, poor circulation of blood may cause it to collect at locations pressed on by the weight of the body, as a result of which parts of the skin may come to take on a reddish tint or become inflamed or cut, resulting in occurrence of bedsores. It is typically the case that the bedsores which occur with such long-term bedridden individuals are not easily prevented merely by postural changes intended to prevent the skin from being pressed on. At the lumbar region and gluteal region where bedsores tend to occur, it is therefore necessary to avoid sweaty conditions such as can result from long-term diaper usage, and to as much as possible maintain these regions in a clean state.

However, cleaning of the lumbar region and gluteal region of a bedridden individual is not easily accomplished while that individual remains confined to bed. Especially where the bedridden individual is an adult, because the body weight of that individual will be large, when the person performing caregiving/nursing attempts raise up the bedridden individual and clean the lumbar region and gluteal region of the bedridden individual, it may occur that the bedridden individual and the person performing the procedure both find that there is a limit to the postures they are capable of assuming, as a result of which adequate cleaning cannot be performed, and the contaminated state remains, it sometimes being the case that injury is inflicted to the skin when that unclean matter is wiped up. Thus, with long-term bedridden individuals, there is a tendency for bedsores to occur due to insufficiency of cleaning, this being one factor that contributes to an even further lowering of the QOL of long-term bedridden individuals. There has thus been no effective cleaning means that would prevent bedsores from occurring in long-term bedridden individuals.

Thus, the shampoo auxiliary tools that have been proposed or used conventionally have many problems from the respective standpoints of manufacturing, use, and storage, and especially within nursing-technology-related academic societies there has been a long-felt need for a novel cleaning auxiliary tool.

### PRIOR ART REFERENCES

### Patent References

Patent Reference No. 1: Japanese Utility Model Registration No. 3112179

Patent Reference No. 1: Japanese Patent Application Publication Kokai No. 2017-200577

### SUMMARY OF INVENTION

### Problem to be Solved by Invention

A problem to be solved by the present invention is to provide a novel cleaning auxiliary tool that will make it possible, while an individual is confined to bed or other such bedding, to perform a shampoo procedure permitting adequate maintenance of shampooing effect of the head hair and the entire head, and especially the back of the head which is located beneath the bedridden individual.

Furthermore, a problem to be solved by the present invention is to provide a novel cleaning auxiliary tool that will make it possible, when performing shampooing on an individual confined to bed or other such bedding, to dramatically reduce the amount of water used while adequately maintaining shampooing effect, and to perform shampooing without causing water to leak during shampooing or causing the bedridden individual or the surroundings to become soiled when performing shampooing.

Furthermore, another problem to be solved by the present invention is to provide a novel cleaning auxiliary tool that will make it possible for a single person to easily put the disposable shampoo tool in place and perform the shampoo procedure while the person undergoing the procedure is confined to bed without causing the sheets on the bed to be moved out of place, that will make it possible easily perform drainage procedures following shampooing without needing to carry out bucket replacement, that will greatly reduce the expense and space required for storage and disposal of the shampoo auxiliary tool, and that will reduce the manufacturing cost thereof.

### Means for Solving Problem

A first means in accordance with the present invention for solving the foregoing problems is a disposable cleaning auxiliary tool, both sides of which are capable of being used, which comprises a flexible sheet-like non-liquid-permeable material, and which has a bottom portion, a duct portion arranged so as to extend further therebeyond from a location serving as soiled water outlet provided at an outer periphery of said bottom portion, a pouch-like water-receiving portion arranged at a surface at one side or surfaces at both sides of an extended tip of said duct portion, a cylindrical gas filled portion arranged at an outer peripheral portion other than the location serving as soiled water outlet at said bottom portion, and a gas filling inlet for filling said cylindrical gas filled portion; wherein the disposable cleaning auxiliary tool is capable of being folded and stored when the cylindrical gas filled portion is not filled with gas; wherein, when the cylindrical gas filled portion has been filled with gas by way of the gas filling inlet, the inflated cylindrical gas filled portion serves as a cylindrical platform for supporting and permitting placement thereon of a portion of the body of a bedridden individual, a cylindrical wall for preventing water from said bottom portion from overflowing, and a cylindrical column that is inserted within the pouch-like water-receiving portion and that makes the pouch-like water-receiving portion capable of standing on its own after receiving water; and wherein the bottom portion is supported and made more or less planar by the inflated cylindrical gas filled portion, a concavity formed when a location at the bottom portion which was made more or less planar and on which a portion of the body of the bedridden individual is placed is pushed downward serves as a reservoir, each time that a portion of a sheet which was made more or less planar is pushed downward a concavity is formed that serves as a drainage path causing water to be guided from said reservoir to the duct portion and the pouch-like water-receiving portion.

Here, because the aforementioned disposable cleaning auxiliary tool, both sides of which are capable of being used, comprises a flexible sheet-like non-liquid-permeable material, it is capable of being folded and stored when the cylindrical gas filled portion is not filled with gas. By folding it and stacking it, it can stored in a compact folded state, improving its transportability, and also making it possible when large numbers of the disposable cleaning auxiliary tool are to be warehoused for this to be accomplished without taking up much space. Furthermore, because it comprises a flexible sheet-like non-liquid-permeable material, although the fact that it is too soft when in its unfolded state makes it difficult to insert beneath the body of a bedridden individual, due to the fact that it is capable of being folded, the disposable cleaning auxiliary tool in accordance with the means of the present invention, both sides of which are capable of being used, can, when made to assume a compact folded state, while in that state be inserted beneath the body of a bedridden individual as it is lifted up, from which state it may easily be unfolded. Furthermore, by releasing a little gas from the cylindrical gas filled portion, it is possible to appropriately collapse the cylindrical gas filled portion which comprises flexible sheet-like material, making it easier for this to be pulled out therefrom together with the bottom portion. Thus, the disposable cleaning auxiliary tool also makes it possible for a worker to perform operations by himself or herself.

In addition, the aforementioned disposable cleaning auxiliary tool, both sides of which are capable of being used, is such that the inflated cylindrical gas filled portion functions as a cylindrical platform for supporting and permitting placement thereon of a portion of the body of a bedridden individual. By causing the cylindrical gas filled portion to be filled with gas by way of the gas filling inlet so as to appropriately inflate it, it is possible to make it conform to the postural state of the bedridden individual. It is possible even with a long-term bedridden individual whose back is bent for the body to be placed and retained thereon in such manner that no discomfort is inflicted, and changes in the posture are also easily accomplished. Furthermore, in the event that the bedridden individual should complain of discomfort during the course of the cleaning procedure due to the fact that the cylindrical gas filled portion is filled with too much gas, it is possible even during the course of the cleaning procedure to release some of the gas with which this is filled, thereby allowing adjustment as appropriate of the height and hardness of the cylindrical gas filled portion, and making it possible to lessen the discomfort of the bedridden individual. Furthermore, when performing the cleaning procedure, by increasing the amount of gas with which this is filled and causing the cylindrical wall to be well-formed, it is possible to more definitively prevent water from overflowing from the bottom portion.

Furthermore, the bottom portion is supported and made more or less planar by the inflated cylindrical gas filled portion; moreover, because it comprises a flexible sheet-like non-liquid-permeable material, a concavity formed when a location at the bottom portion which was made more or less planar and on which a portion of the body of the bedridden individual is placed is pushed downward serves as a reservoir. Because the concavity is formed only at the portion that is pushed downward, water does not flow at bottom portions that are more or less planar, and it is possible to efficiently cause the water used for cleaning to be retained at the periphery of the body of the bedridden individual. In particular, with regard to the cleaning procedure when performed on the body of a bedridden individual which produces an old person smell, while it is known that the substance that causes the old person smell can be efficiently cleaned and that generation of this odor can be effectively prevented by using water at on the order of 41° C., by causing a concavity which serves as reservoir to be formed only at the periphery of the location at which a portion of the body of the bedridden individual is placed, as is the case in the disposable cleaning auxiliary tool in accordance with the means of the present invention, because the water which is on the order of 41° C. is not made to flow across a planar surface but is made to collect in a reservoir formed by the concavity, and because the surface of the water that is in contact with the air is smaller than would be the case with a planar surface, decrease in temperature of the water is prevented, as a result of which good cleaning effect can be maintained. Furthermore, because water is reliably made to collect in the reservoir formed by the concavity, rinsing effect is also good. Moreover, because a worker can, appropriately and as needed, push downward on a portion of the sheet that has been made more or less planar, a concavity being formed in the bottom portion that serves as drainage path causing water to be guided from said reservoir to the duct portion and the pouch-like water-receiving portion each time that this is pushed downward, it is possible to cause drainage of water to occur in well-timed fashion in correspondence to the contaminated state of the water that has collected thereat, making it possible to achieve efficiency in cleaning operations.

In addition, after water has collected in the pouch-like water-receiving portion following cleaning, when the disposable cleaning auxiliary tool in accordance with the means of the present invention is to be removed from where it is beneath the bedridden individual and further caregiving is to be provided to the bedridden individual, because it comprises a flexible sheet-like material, it would, if it were to be used in that state, immediately collapse, and cause the wastewater that has accumulated following cleaning to overflow therefrom. But because the disposable cleaning auxiliary tool in accordance with the means of the present invention comprises a flexible sheet-like material, it is possible to cause the inflated cylindrical gas filled portion to be such that by folding the duct portion over and inserting it into the pouch-like water-receiving portion as this exists following cleaning, and using this as a cylindrical column that will make the pouch-like water-receiving portion which has received water capable of standing on its own, the disposable cleaning auxiliary tool in accordance with the means of the present invention, which contains wastewater that has accumulated following cleaning, is made able to stand on its own on the floor without causing the pouch-like water-receiving portion that has received water to collapse.

In addition, as the disposable cleaning auxiliary tool in accordance with the means of the present invention is provided with pouch-like water-receiving portion(s) arranged at a surface at one side or surfaces at both sides of an extended tip of said duct portion, the disposable cleaning auxiliary tool is such that both sides thereof are capable of being used, inasmuch as it is capable of being used regardless of which side of the duct portion is made to serve as the top surface. When the pouch-like water-receiving portion is at a surface at one side, by causing this to be arranged in such fashion that the pouch-like water-receiving portion is made to serve as the top surface, it will be possible to cause the soiled water from the duct portion to be retained by the pouch-like water-receiving portion. Furthermore, in situations such as where it may be expected in advance that a large amount of water will be used during cleaning, by causing this to be arranged in such fashion that the pouch-like water-receiving portion is made to serve as the bottom surface, and by causing the duct portion to enter a bucket or other such large-scale water-receiving accessory that is placed beneath the bedside, it will be possible to cause the wastewater that has accumulated following cleaning to collect in the bucket or other such large-scale water-receiving accessory. Thus, the disposable cleaning auxiliary tool in accordance with the means of the present invention has a structure that allows it to be capable of flexibly accommodate a change in the surface that will be used in correspondence to the amount of water that will be used.

A second means in accordance with the present invention for solving the foregoing problems is the disposable cleaning auxiliary tool according to the first means in accordance with the present invention wherein the gas filling inlet is provided with a mechanism for preventing backflow of gas from the cylindrical gas filled portion. By providing it with a gas backflow prevention mechanism, it is possible to cause the cylindrical gas filled portion to be filled with gas a little at a time and for fine adjustments to be made to the degree to which it is inflated as this is made to conform to the state of the body of the bedridden individual.

A third means in accordance with the present invention for solving the foregoing problems is the disposable cleaning auxiliary tool according to the first means or the second means in accordance with the present invention wherein, when the cylindrical gas filled portion has been filled with gas by way of the gas filling inlet, the cylindrical gas filled portion is U-shaped, C-shaped, or in the shape of the character [symbol] .

A fourth means in accordance with the present invention for solving the foregoing problems is the disposable cleaning auxiliary tool according to any one of the first means through the third means in accordance with the present invention used by causing the duct portion to hang down from a side face of a bed or futon bedding on which the bedridden individual is placed, causing an opening at the pouch-like water-receiving portion provided at an extended portion which is directed upward so as to be capable of receiving soiled water during cleaning of the body of the bedridden individual. Because it comprises a flexible sheet-like non-liquid-permeable material, and because it bends flexibly in correspondence to the side face of a bed or futon bedding, it is possible to cause the soiled water to flow straight down, and for the water to be received by the pouch-like water-receiving portion, without causing occurrence of a situation in which contaminated water is scattered about the surrounding area.

A fifth means in accordance with the present invention for solving the foregoing problems is the disposable cleaning auxiliary tool according to any one of the first means through the fourth means in accordance with the present invention wherein the cylindrical gas filled portion length is provided with a depression or slit having a depth which is less than a diameter of the cylindrical gas filled portion.

A sixth means in accordance with the present invention for solving the foregoing problems is the disposable cleaning auxiliary tool according to any one of the first means through the fourth means in accordance with the present invention wherein an outer peripheral side of the cylindrical gas filled portion is provided with a depression or slit.

As described above, by causing a depression or slit to be arranged at the cylindrical gas filled portion when the cylindrical gas filled portion has been filled with gas by way of the gas filling inlet, it is possible, when a bedridden individual lies on the cylindrical gas filled portion when this is in a filled state, to prevent a portion of the cylindrical gas filled portion on which the bedridden individual does not lie from being made to rise up, and to maintain the amount of water that has collected in the reservoir formed by the concavity of the bottom portion. In particular, by causing the depression or slit provided at the cylindrical gas filled portion to be provided at an outer peripheral side of the cylindrical gas filled portion, due to the fact that a depression or slit will be arranged at the outer peripheral side of the cylindrical gas filled portion when the cylindrical gas filled portion has been filled with gas by way of the gas filling inlet, because, when a bedridden individual lies thereon, the cylindrical gas filled portion on which the bedridden individual is lying will tend to collapse toward the bottom portion, and because other portions of the cylindrical gas filled portion will also be pulled on by the bottom portion where this has been pulled downward such that they also will collapse toward the bottom portion, the disposable cleaning auxiliary tool in accordance with the means of the present invention will assume a more stable installed state.

Another means in accordance with the present invention for solving the foregoing problems is a disposable cleaning auxiliary tool characterized in that it comprises a wall portion having a cylindrical gas filled portion that when made to expand by filling with gas and when lain on by a portion of the body of a bedridden individual is roughly U-shaped, roughly C-shaped, or roughly in the shape of the character [symbol] and a gas filling inlet for causing the interior of said gas filled portion to be filled with gas, and a flexible non-liquid-permeable sheet having an extended portion arranged at which there is a pouch-like water-receiving portion at which an opening is provided so as to oppose an opening at the wall portion at which the cylindrical gas filled portion is present and arranged toward the bottom of said wall portion, and in that it also has a bottom portion, and which is such that by causing a cylindrical air filled portion to be filled with gas from the interior of the gas filling portion, the wall portion at which the cylindrical air filled portion that is filled with gas is present causes planarity of said bottom portion to be maintained, and a concavity formed where the sheet is pushed downward at a location at said bottom portion where a portion of the body of the bedridden individual is placed moreover serves as a reservoir, and a concavity formed where the sheet is pushed downward at said extended portion of the sheet serves as a drainage path for guiding water from said reservoir to said pouch-like water-receiving portion.

### Benefit of Invention

The disposable cleaning auxiliary tool in accordance with the means of the present invention has a wall portion having a cylindrical air filled portion that when made to expand by filling with air and placed under the neck of a bedridden individual is U-shaped or in the shape of the character [symbol] and an air filling inlet for causing the interior of said air filled portion to be filled with air, and a bottom portion comprising a flexible non-liquid-permeable sheet having an extended portion arranged at which there is a water-receiving pouch at which an opening is provided so as to oppose an opening at the wall portion at which the cylindrical air filled portion that is U-shaped or in the shape of the character [symbol] is present and arranged toward the bottom of said wall portion, it being possible, after use of the cylindrical air filled portion which is not filled with air before use, for the disposable cleaning auxiliary tool to be stored in a compact folded and stacked state.

Furthermore, when the disposable cleaning auxiliary tool in accordance with the means of the present invention is to be used, by causing the cylindrical air filled portion to be filled with air from the interior of the air filling portion, it is possible to cause the head and neck to be disposed in caring fashion for shampooing, and the wall portion at which the cylindrical air filled portion that is U-shaped or in the shape of the character [symbol] and that is filled with air is present causes planarity of said bottom portion to be maintained, and due to the fact that a concavity formed where the sheet is pushed downward at a location at said bottom portion where the head of the bedridden individual is placed moreover serves as a reservoir makes it possible for it to be converted into a structure having a reservoir capable of causing a prescribed amount of water to be collected therein when being used for shampooing, as a result of which it is possible to adequately obtain shampooing effect of the entire head, which had proven difficult with the conventional art, and especially of the back of the head, cleaning of which had been difficult. In addition, by causing the wall portion at which the cylindrical air filled portion is present when this is filled with air to be of such shape that is not so much C-shaped as it is U-shaped or in the shape of the character [symbol] , such that a roughly linear portion is present, it will be possible to increase the amount of space which is present at the periphery of the head and neck as well as at the opening, making it possible to ensure existence of a compact yet suitable work area, and better facilitating drainage.

Moreover, following shampooing, because a concavity formed where said extended portion of the sheet is pushed downward serves as drainage path for guiding water from said reservoir to said water-receiving pouch, it is possible to efficiently carry out shampooing using an extremely small amount of water, and when the water which has collected in the concavity which serves as reservoir has become soiled, it is possible at any time at all to push downward at said extended portion of the sheet to form a drainage path so as to cause the soiled water to be removed therefrom, and to thereafter stop pushing downward thereon to cause this to return to its original state, and to again use a small amount of clean water, as a result of which it is possible to cause soiled matter to be quickly removed therefrom using an extremely small amount of water, i.e., a mere on the order of 1.5 L, when it had been the case conventionally that the amount of water required for cleaning was 5 L or more. This will be particularly effective during disasters and in regions where there is a limited supply of water.

In addition, while the soiled water is retained in the water-receiving pouch, as it is an extremely small amount, being on the order of 1.5 L, it is light and can be transported even by females, and it is also easily disposed of. Furthermore, during disasters and in regions where there is a limited supply of water, as it is also possible for the soiled water which is retained in the water-receiving pouch to be put to other uses including use as water for toilets or the like, it is more universal in terms of its applications.

In addition, the disposable cleaning auxiliary tool in accordance with the means of the present invention cuts in half the number of preparatory items that had been required before a shampoo could be given to a bedridden individual, and eliminates the variation in and the degree of completion with respect to which handmade items had been dependent on the experience of the user. As the absence of product variation makes it possible for users to devote themselves only to the care of bedridden individuals and in learning how to perform a shampoo, it facilitates the arising of a reassuredness that allows improvement in effective greeting, touching, and other such caregiving/nursing techniques. Moreover, by making it possible for shampooing to be conveniently carried out by anyone without getting the bedridden individual or the ambient surroundings wet, it also makes it possible to complete the task using a small amount of water, i.e., on the order of 1.5 L, when it had been the case conventionally that an amount corresponding to 5 L was used, and because a bucket is not required it also makes it possible not to have to worry about hygienic procedures or cleanup afterwards. Furthermore, inasmuch as the amount is as little as this, a general purpose water bottle or the like having thermos-like capability may be brought to the bedside, and water that is on the order of 41° C. may be poured out a little at a time, it being easy to perform cleaning while this remains unchanged within that temperature range, and it is possible to efficiently reduce amounts of substances that cause occurrence of old person smell or the like, and to achieve better cleaning effect.

Furthermore, cleaning of the lumbar region and gluteal region of a bedridden individual is not easily accomplished while that individual remains confined to bed, and where the period during which the bedridden individual has been confined to bed continues for a long time there will be occurrence of bedsores due to insufficient cleaning of the regions in question. Because such bedsores cannot be prevented by postural changes intended to prevent the skin from being pressed on, they are a factor that contributes to worsening of the QOL of bedridden individuals. But by using the disposable cleaning auxiliary tool in accordance with the means of the present invention, without having to raise up and move the bedridden individual but by inserting said disposable cleaning auxiliary tool into the gap produced when the body of the bedridden individual is lifted slightly and causing the cylindrical air filled portion to be filled with an appropriate amount of air by way of the air filling inlet, postural changes of the bedridden individual can be facilitated.

Moreover, because a slight concavity formed when the flexible sheet at the bottom portion with which the disposable cleaning auxiliary tool in accordance with the means of the present invention is equipped is pushed downward by the body of the bedridden individual functions as a reservoir, and because a flow path is easily formed, permitting wastewater from cleaning to drain therefrom, when the person performing the procedure pushes downward on the sheet, it is possible to cause cleaning of regions such as the lumbar region, gluteal region, and so forth, cleaning of which had conventionally been difficult while the individual remained confined to bed, to be carried out properly using an extremely small amount of water. In addition, occurrence of bedsores caused by insufficient cleaning that could not be prevented by postural changes intended to prevent the skin from being pressed on is suppressed, and it is possible for the state of any bedsores that have already occurred to be made to improve, permitting dramatic improvement in the QOL of long-term bedridden individuals.

Furthermore, while cleaning with a small amount of water is made possible as described above, there are also situations in which cleaning must be performed with a larger amount of water, such as when the contaminated state is severe, as may be the case with the gluteal region. As the disposable cleaning auxiliary tool in accordance with the means of the present invention is provided with pouch-like water-receiving portion(s) arranged at a surface at one side or surfaces at both sides of an extended tip of a duct portion, because the disposable cleaning auxiliary tool is such that both sides thereof are capable of being used, inasmuch as it is capable of being used regardless of which side of the duct portion is made to serve as the top surface, by causing it to be arranged in such fashion that the pouch-like water-receiving portion is made to serve as the bottom surface, and by causing the duct portion to enter a bucket or other such large-scale water-receiving accessory that is placed beneath the bedside, so as to cause the wastewater that has accumulated following cleaning to collect in the bucket or other such large-scale water-receiving accessory, cleaning can easily be performed with large amount of water.

In addition, work operations performed by the person performing the procedure are simplified, less time is required to carry out cleaning, and dramatic reduction is achieved in the physical load that had been experienced by the person performing the procedure due to the work involved in effecting postural changes of the bedridden individual. In addition, employment of the disposable cleaning auxiliary tool in accordance with the means of the present invention makes it possible to formulate standardized work procedures, and permits widespread provision of a high procedural level of caregiving/nursing services regardless of the degree of proficiency of the persons performing the procedures.

### BRIEF DESCRIPTION OF DRAWINGS

FIG. 1 is a drawing to assist in describing how one embodiment of a disposable cleaning auxiliary tool in accordance with a means of the present invention might be used.

FIG. 2 is a front view of an embodiment of a disposable cleaning auxiliary tool in accordance with a means of the present invention.

FIG. 3 is a rear view of an embodiment of a disposable cleaning auxiliary tool in accordance with a means of the present invention.

FIG. 4 is a right side view of an embodiment of a disposable cleaning auxiliary tool in accordance with a means of the present invention.

FIG. 5 is a left side view of an embodiment of a disposable cleaning auxiliary tool in accordance with a means of the present invention.

FIG. 6 is a plan view of an embodiment of a disposable cleaning auxiliary tool in accordance with a means of the present invention.

FIG. 7 is a bottom view of an embodiment of a disposable cleaning auxiliary tool in accordance with a means of the present invention.

FIG. 8 is a (a) front view (FIG. 8 (a); and rear view at FIG. 8 (b)) of another embodiment of a disposable cleaning auxiliary tool in accordance with a means of the present invention.

FIG. 9 is a drawing to assist in describing how another embodiment of a disposable cleaning auxiliary tool in accordance with a means of the present invention might be used.

FIG. 10 is a drawing to assist in describing how a disposable cleaning auxiliary tool in accordance with a means of the present invention might be used.

FIG. 11 is a drawing to assist in describing how a disposable cleaning auxiliary tool in accordance with a means of the present invention might be used.

FIG. 12 is a drawing to assist in describing how a disposable cleaning auxiliary tool in accordance with a means of the present invention might be used.

### EMBODIMENTS FOR CARRYING OUT INVENTION

Below, embodiments for carrying out the present invention are described as appropriate with reference to the drawings below.

### Disposable Shampoo Tool Materials

While there is no particular limitation with respect to the material(s) employed in the disposable cleaning auxiliary tool (1) in accordance with the means of the present invention so long as it is a soft resin capable of being molded into non-liquid-permeable flexible sheeting, considering the fact that it should be manufactured at low cost and that it should be such as to permit little space to be taken up when it is stored, a film-like substance made of resin is employed, it being preferred that a film-like material made of soft plastic or soft vinyl be employed. It is more preferred that polyethylene film or the like or a film made of resin such as polypropylene film be employed. So as to make it possible for part of the weight of the body of a bedridden individual placed thereon to form a concavity at a bottom portion thereof, thickness of the film is on the order of 0.015 mm to 0.05 mm, on the order of 0.02 mm to 0.04 mm being preferred, and on the order of 0.02 mm to 0.03 mm being more preferred. Furthermore, so long as it is of such thickness as to make it possible for the weight of the head of a bedridden individual to form a concavity at a bottom portion thereof, it is also possible to employ composite sheeting in which film made of resin and nonwoven fabric and/or metal film are laminated together by means of heat, adhesive, or the like. Furthermore, so long as it is such as to make it possible for the weight of the head of a bedridden individual to form a concavity at a bottom portion thereof, there is no objection to employment of single-ply film sheeting or multi-ply film sheeting made up two or more plies.

Furthermore, because employment of a check valve at the gas filling inlet for causing the interior of the gas filled portion to be filled with gas will make it possible for workers to efficiently perform the air filling procedure, and will facilitate unimpeded performance of the procedure when the procedure is being done by a single person, it is preferred. As the gas, besides the breath of the worker and air, it is also possible to employ any of various types of gases. Furthermore, a canister, pump, or the like may be employed to cause this to be filled with the necessary amount of air or other such gas by way of the gas filling inlet.

### Manufacturing Method

Any of various adhesive and/or bonding means such as heat-sealing, adhesive, compression bonding, ultrasonic bonding, or the like may be used to manufacture the disposable cleaning auxiliary tool in accordance with the means of the present invention using soft resin sheeting that is non-liquid-permeable and flexible such as has been indicated at Materials, above. For example, a member having cylindrical sheeting which will serve as a cylindrical gas filled portion and having a check valve or other such air backflow prevention mechanism, a bottom portion, a duct portion arranged so as to extend further therebeyond from a location which will serve as soiled water outlet provided at the outer periphery of the bottom portion, and the aforementioned soft resin sheeting which will form a pouch-like water-receiving portion arranged at the surface at one side or the surfaces at both sides of the extended tip of said duct portion may be stacked atop each other, and heat-sealing, adhesive, compression bonding, or ultrasonic bonding may be used to carry out adhesion/bonding to form the cylindrical gas filled portion, check valve or other such air backflow prevention mechanism which is arranged at the cylindrical gas filled portion, bottom portion, duct portion which is arranged so as to extend further therebeyond from a location serving as soiled water outlet provided at the outer periphery of the bottom portion, and pouch-like water-receiving portion arranged at the surface at one side or the surfaces at both sides of the extended tip of said duct portion in accordance with the means of the present invention. Furthermore, by using soft-resin pouch-like sheeting that is non-liquid-permeable and flexible, causing a check valve or other such air backflow prevention mechanism to be arranged at a location which will serve as a cylindrical gas filled portion, using a die to perform heat-sealing at a temperature of around 200° C., and cutting an opening at a pouch-like water-receiving portion arranged at the surface at one side or the surfaces at both sides of the extended tip of a duct portion, it is also possible to manufacture a disposable cleaning auxiliary tool, both sides of which are capable of being used, and which comprises a flexible sheet-like non-liquid-permeable material, in accordance with the present invention. Furthermore, by causing one end of a soft-resin sheeting material that is non-liquid-permeable and flexible to be folded back upon itself to form a location which will serve as a cylindrical gas filled portion, causing a check valve or other such air backflow prevention mechanism to be captured therebetween at a portion thereof, causing the other end of said sheeting material to be folded back upon itself so as to form a pouch-like water-receiving portion, and using a die to cause heat-sealing to be respectively performed at the peripheral edges at the location which will serve as cylindrical gas filled portion and at which the check valve or other such air backflow prevention mechanism is captured, and at the location at which the pouch-like water-receiving portion will be formed, it is also possible to manufacture a disposable cleaning auxiliary tool, both sides of which are capable of being used, and which comprises a flexible sheet-like non-liquid-permeable material, in accordance with the present invention.

### Usage Procedure

As an example of a usage procedure for a disposable cleaning auxiliary tool (1) in accordance with the means of the present invention, a procedure that may be employed when carrying out shampooing is indicated below.

1. A disposable cleaning auxiliary tool (1) in accordance with the means of the present invention which is folded up is taken out and is unfolded.

2. Air is blown into the interior of the cylindrical gas filled portion by way of the gas filling inlet (3) to cause the interior thereof to become filled with air and cylindrical in shape. Because placement of the bedridden individual's neck thereon will cause an increase in pressure which will tend to cause the wall portion on the side opposite the side on which the bedridden individual's neck is placed to rise up, care should be taken not to blow too much air thereinto. Where a depression or slit is provided at the wall face, because the reduced thickness at the part of the wall portion corresponding to the depression (10) or slit (10) allows the cylindrical gas filled portion (2) to flex, this will suppress the tendency of the wall portion to rise up; but even where this is the case, too much air should not be blown thereinto.

3. Standing at the bedside of the bedridden individual who is the subject of the shampoo procedure, while supporting the head of the bedridden individual with one hand, the other hand is used to remove the pillow that was being used, and the wall portion at which the cylindrical gas filled portion (2) of the disposable cleaning auxiliary tool (1) which has been inflated with air is present is inserted beneath the neck of the bedridden individual.

4. The disposable cleaning auxiliary tool (1) is arranged in such fashion as to allow the portion which extends from the bottom portion thereof to hang against the side face of the bed, and the head of the bedridden individual is then gently moved down onto the bottom portion. Investigation is carried out to confirm that the weight of the head of the bedridden individual has caused a concavity (11) to form at the bottom portion (7).

5. If a finger sinks easily when pressed into the wall portion at which the cylindrical gas filled portion is present, a little additional air should be blown thereinto by way of the gas filling inlet (3) in supplemental fashion.

6. Cleaning of the head and head hair is begun. A small amount of water sufficient to cause water to flow into and collect in the concavity at the bottom portion of the disposable cleaning auxiliary tool (1) is poured onto the head of the bedridden individual from a polyethylene terephthalate bottle or other such container of on the order of 500 mL filled with water.

7. The water that has collected therein is repeatedly taken up in the hands and poured on the head of the bedridden individual to adequately moisten the head hair and scalp.

8. The portion of the sheet in the duct portion and flat portion of the bottom portion where water does not collect is pushed downward to produce a concavity in the sheet and form a drainage path (14), and the water is guided toward the water-receiving pouch (8) and is made to drain thereinto.

9. Shampoo is used to clean the head hair and scalp of the bedridden individual.

10. The hands are used to clear away as much of the foam from the shampoo as is possible.

11. A small amount of water sufficient to cause water to flow into and collect in the concavity (11) at the bottom portion of the disposable cleaning auxiliary tool (1) is poured onto the head of the bedridden individual from a polyethylene terephthalate bottle or other such container.

12. The water that has collected therein is repeatedly taken up in the hands and poured on the head of the bedridden individual to wash away the shampoo.

13. The extended portion of the sheet is pushed downward to produce a concavity in the extended portion and form a drainage path (14), and the water is guided toward the pouch-like water-receiving portion (8) and is made to drain thereinto.

14. The procedure at 11 through 13 is repeated several times.

15. The head hair and scalp of the bedridden individual are treated with conditioner (or treatment formula).

16. The procedure at 11 through 13 is repeated several times.

17. A towel or the like is used to wipe the moisture from the head hair and scalp of the bedridden individual.

18. While supporting the head of the bedridden individual with one hand, the other hand is used to remove the disposable cleaning auxiliary tool (1) and to insert the pillow therebeneath.

19. The soiled water (15) that has collected in the pouch-like water-receiving portion (8) of the disposable shampoo tool (1) is discarded. By cutting the portion below the pouch-like water-receiving portion (8), the soiled water can be easily discarded. Where there is a separate intended use for the soiled water such as for flushing of a flush toilet, this may be carried to the location where it will be used without cutting the portion below the pouch-like water-receiving portion (8) so that it may be used thereat.

### WORKING EXAMPLE 1

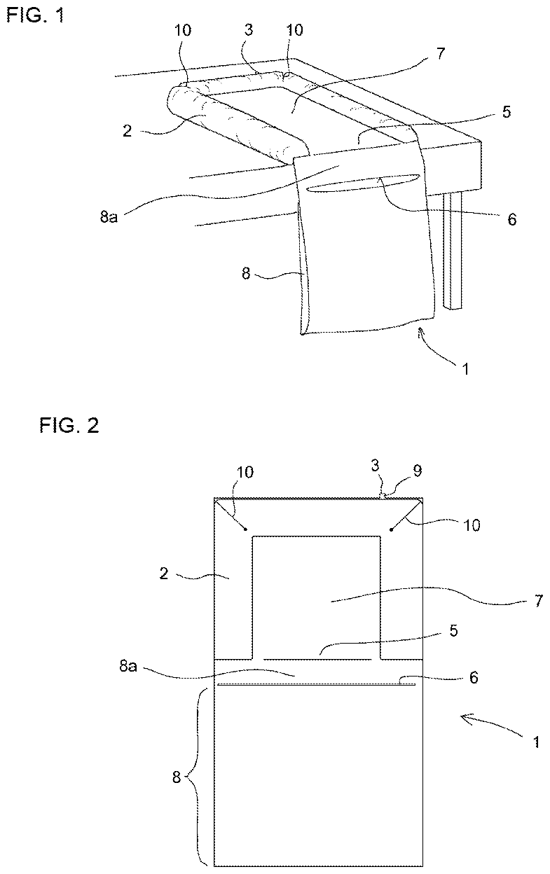

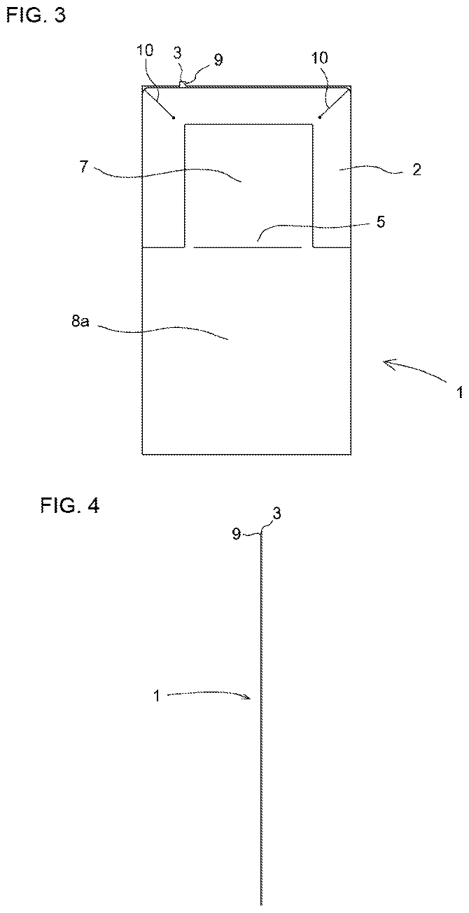

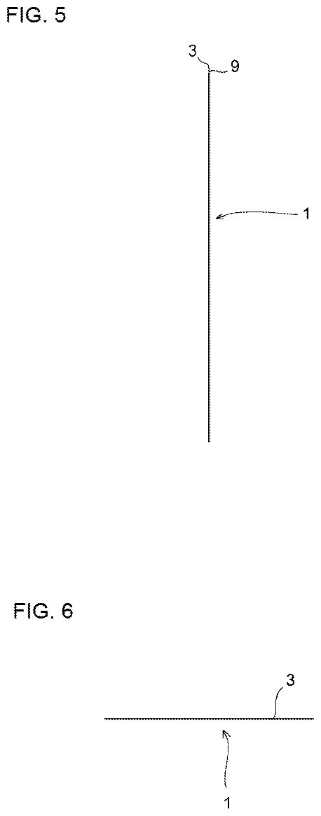

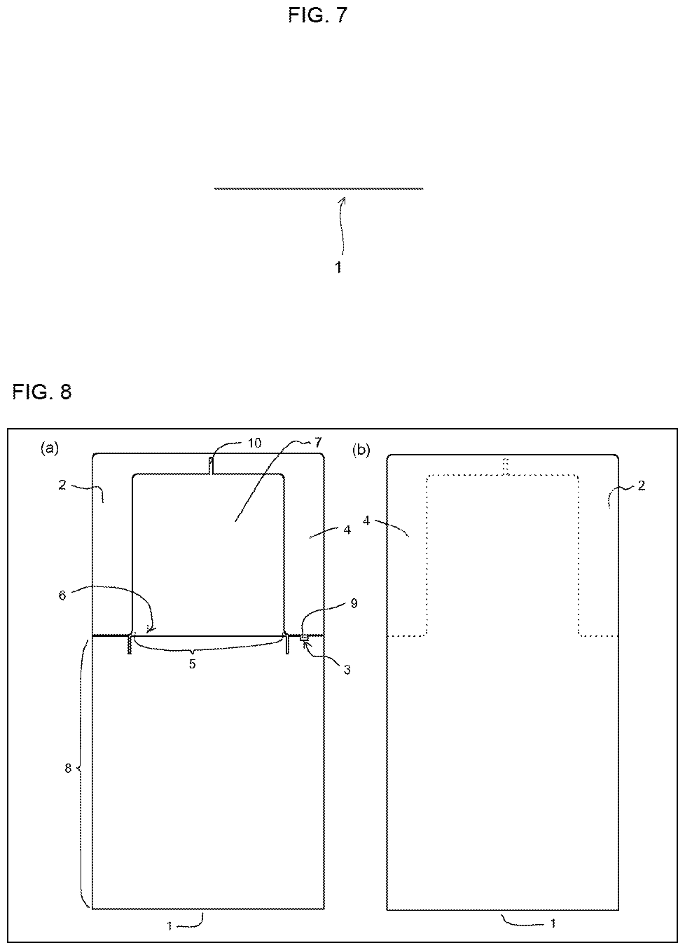

As a disposable cleaning auxiliary tool in accordance with the means of the present invention, pouch-like polyethylene film of thickness 0.03 mm was used, heat-sealing being carried out at a temperature of around 200° C. to cause adhesion of members corresponding to a cylindrical gas filled portion and a gas filling inlet having an air backflow prevention mechanism, following which an open portion was cut into a pouch-like water-receiving portion so as to cause the pouch-like water-receiving portion to be provided with an opening, to manufacture a disposable cleaning auxiliary tool having a structure as shown in FIG. 1 through FIG. 7 (Working Example 1).

### WORKING EXAMPLE 2

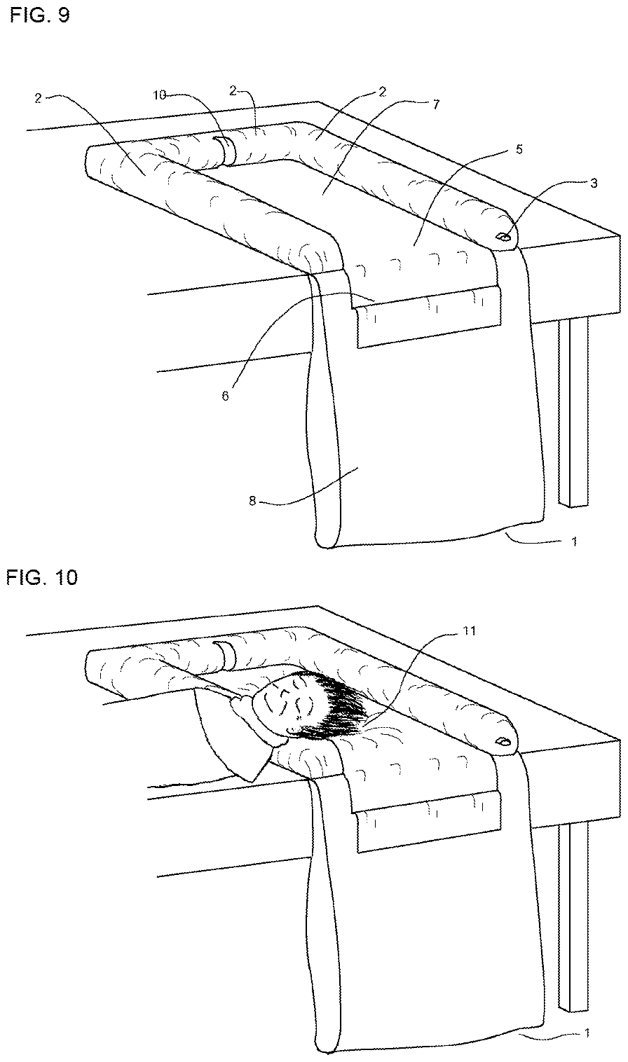

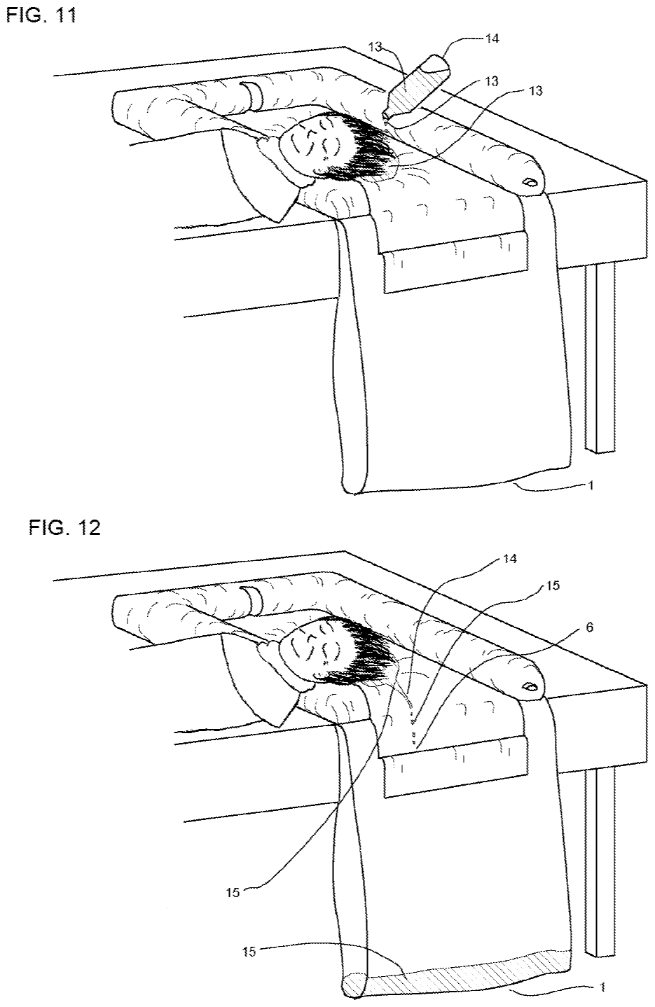

As a disposable cleaning auxiliary tool in accordance with the means of the present invention, pouch-like polyethylene film of thickness 0.03 mm was used, and hot-melt adhesive was used to cause adhesion of the respective parts, to manufacture a disposable cleaning auxiliary tool having a structure as shown in FIG. 8 through FIG. 12 (Working Example 2).

### WORKING EXAMPLE 3

The disposable shampoo tools manufactured at Working Example 1 and Working Example 2 were used in accordance with the foregoing usage procedure to clean the head hair and scalp of a bedridden individual. As a Comparative Test, cleaning of the scalp and head hair at the head of a bedridden individual was carried out using a conventional Kelly-pad-type shampoo tool.

When the disposable cleaning auxiliary tools of Working Example 1 and Working Example 2, these being disposable cleaning auxiliary tools in accordance with the means of the present invention, were used, it was possible in each case for all operations from preparation to completion of cleaning to be performed by a single person. Moreover, cleaning was completed using a mere 1.5 L of cleaning water. There was moreover no occurrence of water leakage during cleaning. And when the reverse side was used as well, it was likewise possible in each case for all operations from preparation to completion of cleaning to be performed by a single person. While the contaminated water was allowed to collect in a bucket, there was no leakage of wastewater, and cleaning was completed using a mere 1.5 L of cleaning water. On the other hand, when the conventional-type shampoo tool of the Comparative Test was used, more than 5 L of cleaning water was required. Furthermore, it was difficult for all operations from preparation to completion of cleaning to be performed by a single person, the bucket needed to be replaced frequently, and there was occurrence of water leakage.

Furthermore, upon investigating the odor from the head before and after cleaning, it was found when a disposable cleaning auxiliary tool in accordance with the means of the present invention was used to perform cleaning using 1.5 L of water at 41° C. that the odor was less following cleaning. In contradistinction thereto, it was found when a conventional shampoo tool was used to perform cleaning using 1.5 L of water at 41° C. that cleaning was inadequate, oily components and so forth remained on the scalp, and the odor of the head remained unchanged relative to what it had been before cleaning.

### WORKING EXAMPLE 4

Moreover, the disposable shampoo tools manufactured at the foregoing Working Examples 1 and 2 were also used to carry out cleaning of the lumbar region or gluteal region of a bedridden individual. As a result, in similar fashion as when carrying out the foregoing shampooing, it was likewise possible for all operations from preparation to completion of cleaning to be performed by a single person without causing leakage of water. Furthermore, it was possible to finish cleaning using an amount of cleaning water used that was 1.5 L, and by using an additional 1 L it was also possible to satisfactorily ensure cleanliness of the gluteal region in particular. It was also found that changes in the posture of the bedridden individual could be easily accomplished.

On the other hand, with the conventional shampoo tool used for the foregoing comparison, as water immediately flowed over the rubber surface, to perform cleaning it was necessary to continuously pour water on the bedridden individual, and a large amount of water was required. Moreover, when the amount of water was changed, the rubber jerked up, causing the contaminated water to spill into the surrounding area.

### EXPLANATION OF REFERENCE NUMERALS

1 Disposable cleaning auxiliary tool
2 Cylindrical gas filled portion
3 Gas filling inlet
4 Wall portion
5 Opening at wall portion where cylindrical gas filled portion is present
6 Opening at pouch-like water-receiving portion
7 Bottom portion
8 Pouch-like water-receiving portion
8a Duct portion
9 Air backflow prevention mechanism
10 Depression or slit in wall face
11 Concavity formed where sheet is pushed downward at location at bottom portion where head of bedridden individual is placed; i.e., reservoir
12 Polyethylene terephthalate bottle
13 Water
14 Concavity formed where sheet is pushed downward at extended portion of sheet; i.e., drainage path for guiding water from reservoir to pouch-like water-receiving portion
15 Soiled water

1. A disposable cleaning auxiliary tool, both sides of which are capable of being used, which comprises a flexible sheet-like non-liquid-permeable material, and which has a bottom portion, a duct portion arranged so as to extend further therebeyond from a location serving as soiled water outlet provided at an outer periphery of said bottom portion, a pouch-like water-receiving portion arranged at a surface at one side or surfaces at both sides of an extended tip of said duct portion, a cylindrical gas filled portion arranged at an outer peripheral portion other than the location serving as soiled water outlet at said bottom portion, and a gas filling inlet for filling said cylindrical gas tilled portion;
wherein the disposable cleaning auxiliary tool is capable of being folded and stored when the cylindrical gas filled portion is not filled with gas;
wherein, when the cylindrical gas filled portion has been filled with gas by way of the gas filling inlet, the inflated cylindrical gas filled portion serves as a cylindrical platform for supporting and permitting placement thereon of a portion of the body of a bedridden individual, a cylindrical wall for preventing water from said bottom portion from overflowing, and a cylindrical column that is inserted within the pouch-like water-receiving portion and that makes the pouch-like water-receiving portion capable of standing on its own after receiving water; and
wherein the bottom portion is supported and made more or less planar by the inflated cylindrical gas filled portion, a concavity formed when a location at the bottom portion which was made more or less planar and on which a portion of the body of the bedridden individual is placed is pushed downward serves as a reservoir, each time that a portion of a sheet which was made more or less planar is pushed downward a concavity is formed that serves as a drainage path causing water to be guided from said reservoir to the duct portion and the pouch-like water-receiving portion.

2. The disposable cleaning auxiliary tool according to claim 1 wherein the gas filling inlet is provided with a mechanism for preventing backflow of gas from the cylindrical gas filled portion.

3. The disposable cleaning auxiliary tool according to claim 1 wherein, when the cylindrical gas filled portion has been filled with gas by way of the gas filling inlet, the cylindrical gas filled portion is U-shaped, C-shaped, or in the shape of the character [symbol] .

4. The disposable cleaning auxiliary tool according to claim 1 used by causing the duct portion to hang down from a side face of a bed or futon bedding on which the bedridden individual is placed, causing an opening at the pouch-like water-receiving portion provided at the extended portion which is directed upward so as to be capable of receiving soiled water during cleaning of the body of the bedridden individual.

5. The disposable cleaning auxiliary tool according to claim 1 wherein the cylindrical gas filled portion length is provided with a depression or slit having a depth which is less than a diameter of the cylindrical gas filled portion.

6. The disposable cleaning auxiliary tool according to claim 1 wherein an outer peripheral side of the cylindrical gas filled portion is provided with a depression or slit.
